(19) United States
(12) Patent Application Publication
(10) Pub. No.: US 2010/0245015 A1
(43) Pub. Date: Sep. 30, 2010

(54) HOT-FORMING FABRICATION METHOD AND PRODUCT OF MAGNETIC COMPONENT

(76) Inventor: S. R. SHANG, Ta Wu Lung Keelung (TW)

Correspondence Address: Guice Patents PLLC, 12647 Galveston Court #302, Manassas, VA, 20112, US

(21) Appl. No.: 12/559,580

(22) Filed: Sep. 15, 2009

(30) Foreign Application Priority Data
Mar. 31, 2009 (TW) 098110688
Jul. 8, 2009 (CN) 200910151966.4

(51) Int. Cl. H01F 17/04; B29C 71/04; H01F 27/24

(52) U.S. Cl. 336/221; 264/250; 336/233

(57) ABSTRACT

A hot-forming fabrication method of a magnetic component and a hot-formed magnetic component fabricated by the same are provided. More particularly, a magnetic powder hot-forming technique is provided, along with a hot-formed magnetic component fabricated by the hot-forming technique so as to have high inductance, low core loss, and high electromagnetic wave shielding efficiency. A low core low-core loss core for use in a common basic magnetic component is enclosed and thereby shielded by a single-layer or multi-layer EMI shielding material, thus producing an enhanced magnetic component with high inductance, low core loss, and low electromagnetic wave interference.

### BACKGROUND OF THE INVENTION

1. Technical Field

The present invention relates to a hot-forming fabrication method of a magnetic component and a hot-formed magnetic component fabricated by the same, wherein the hot-forming fabrication method and the hot-formed magnetic component are applicable to large-current power inductors, electronic components, electromagnetic control components, and like products with magnetic components.

2. Description of Related Art

In order to solve the problems associated with the windings of conventional magnetic components, columnar cores are gradually being adopted in the related industry. FIG. 9 is a sectional view of a conventional open magnetic component having a current-carrying coil 1 and a columnar core 2. The current-carrying coil 1 generates loops of magnetic field lines that surround the current-carrying coil 1. Most of the field lines diverge outward from the center of the core 2 and become a major source of EMI. Furthermore, as the magnetic field is diverging, it will not enhance the field induction.

With a view to improving the aforesaid open magnetic component, a casing 3 is typically provided outside the core 2 to form a so-called assembling drum core. Please refer to FIG. 10 for a sectional view of a conventional assembling drum core. The drum core has the following two major advantages over the aforesaid open magnetic component:
1. With the casing 3 conducting the field lines into the material of the casing 3, the diverging field lines are reduced.
2. With more magnetic field lines conducting back to magnetic material by external casing, the magnetic field induction will be enhanced.

However, the assembling drum core design described above is disadvantaged by gaps 31 (as shown by the hatched areas in FIG. 10) between components of the assembling drum core. Since the drum core is an assembly of multiple components, the gaps 31 are unavoidable. More importantly, these gaps 31 contribute to more than 50% of core loss.

### BRIEF SUMMARY OF THE INVENTION

The primary objectives of the present invention are:
1. Applying a hot-forming technique of the present invention to a basic magnetic component so as to tightly enclose the magnetic material of the magnetic component, thereby producing an enhanced magnetic energy storage component and solving the aforementioned problems of the prior art, namely divergence of field lines and gaps in the assembly; and
2. Using a low core loss and high permeability material and a highly effective electromagnetic wave shielding material developed by the present invention to further improve the performance of the enhanced energy storage component.

To achieve the above and other objectives, the present invention provides the following technical solutions:

The present invention provides a hot-forming fabrication method of a magnetic component, wherein the method includes the steps of: winding a current-carrying coil 1 around a core 2 so as to form a magnetic energy storage component A; placing the magnetic energy storage component A in a mold, and disposing a magnetic shielding material 4 around the magnetic energy storage component A; and performing a hot-forming process so as to obtain a hot-formed magnetic component B enclosed by the magnetic shielding material 4.

The present invention also provides a hot-formed magnetic component including a core 2, a current-carrying coil 1 wound around the core 2, and a magnetic shielding material 4 enclosing the core 2 and the current-carrying coil 1 by a hot-forming process.

A comparison between the present invention and the prior art is presented below.

The hot-forming technique of the present invention essentially involves a heating and pressing process, whereby a hot-forming powder is heated until it is softened and liquefied, and then the molten powder is formed in a mold so as to enable complicated form features such as bent, hollow, or miniaturize parts.

On the other hand, the conventional cold-pressing technique is carried out by pressing a powder into shape, mainly via a mechanical pressing process, and then annealing and sintering the semi-product so as to form the finished product. The conventional magnetic components are all fabricated by this powder cold-pressing technique.

The table below shows a comparison between the hot-forming technique of the present invention and the conventional cold-pressing technique in terms of fabricating magnetic components.

| | | Hot forming (present | Note on the present |
|---|---|---|---|
| Item | Cold pressing | invention) | invention |
| Heat resistance of | Poor, as the | High, as the | High-temperature |
| component/unit | component/unit is | component/unit is | binder and lubricant |
| | formed at room | formed at high | are required. |
| | temperature | temperature (>180° C.) | |
| Electric resistivity of | Low | High | Hot-forming powder is |
| component | | | heated to provide the |
| | | | better insulating |
| | | | enclosure. |
| Eddy current | High | Low | Eddy current decreases |
| | | | as electric resistivity |
| | | | increases. |
| Core loss | High | Low | Core loss decreases |
| | | | as electric resistivity |
| | | | increases. |
| Probability of cracking | High | Low | The better bond is |
| | | | provided by the higher |
| | | | percentage of plastic |
| | | | material in the |
| | | | component. |
| Complicated form | Only those suitable for | Complex, delicated | |
| features | being axially formed | features | |
| Feasibility of | No | High | Can be integrated with |
| modularization | | | heat dissipation fins, a |
| | | | base, etc. |
| Density uniformity | Poor | Good | Hot-forming plastic is |
| | | | heated and softened. |
| Ease of coil winding | Difficult | Easy | No special tooling are |
| | | | required for coil |
| | | | winding. |
| Damage of coil | Likely | Unlikely | The component has |
| insulation | | | the smoother surface. |
| EMI noise | High | Low | The component is |
| | | | enclosed by EMI |
| | | | shielding material. |
| Annealing process | Required | Not required | |
| Component aging | Fast | Slow | Formed at high |
| | | | temperature and hence |
| | | | less likely to age |
| | | | because of |
| | | | temperature. |
| Anti-rust ability | Poor | Good | The component has |
| | | | the higher percentage |
| | | | of plastic material. |

### BRIEF DESCRIPTION OF THE SEVERAL VIEWS OF THE DRAWINGS

The structure and technical means adopted by the present invention to achieve the above and other objectives can be best understood by referring to the following detailed description of the preferred embodiments and the accompanying drawings, wherein:

FIG. 1 is a sectional view of a hot-formed magnetic component according to the present invention;

FIG. 2 is a sectional view of a combination of a core and a current-carrying coil according to the present invention, wherein the combination is different from that of FIG. 1;

FIG. 3 is a sectional view of another combination of the core and the current-carrying coil according to the present invention;

FIG. 4 is a sectional view of yet another combination of the core and the current-carrying coil according to the present invention;

FIG. 5 is a sectional view of still another combination of the core and the current-carrying coil according to the present invention;

FIG. 6 is a schematic drawing showing major steps of a hot-forming fabrication method of a magnetic component according to the present invention;

FIG. 7 is a block diagram showing actions and sub-actions taken in the present invention to hot-form a magnetic powder into a magnetic component;

FIG. 8 is a schematic drawing of a hot-forming apparatus according to the present invention;

FIG. 9 is a sectional view of a conventional open magnetic component having a columnar core;

FIG. 10 is a sectional view of a conventional drum core;

FIG. 11A shows the dimensions of a device as an embodiment of the present invention;

FIG. 11B shows the dimensions of a T-shaped core used in the device of FIG. 11A;

FIG. 12 is a side perspective view of three finished products of the device according to the embodiment of present invention;

FIG. 13 is a front perspective view of the finished products shown in FIG. 12; and

FIG. 14 is a top view of the finished products shown in FIG. 12.

### DETAILED DESCRIPTION OF THE INVENTION

As used herein, the word “component” is generally defined as a functioning magnetic component which is formed by a magnetic material externally provided with such additional elements as a coil, a circuit, a coating, etc. and which is useful in inductive, electromagnetic, and like applications. The word “core” as used herein refers to a magnetic induction core bar enclosed in the magnetic component.

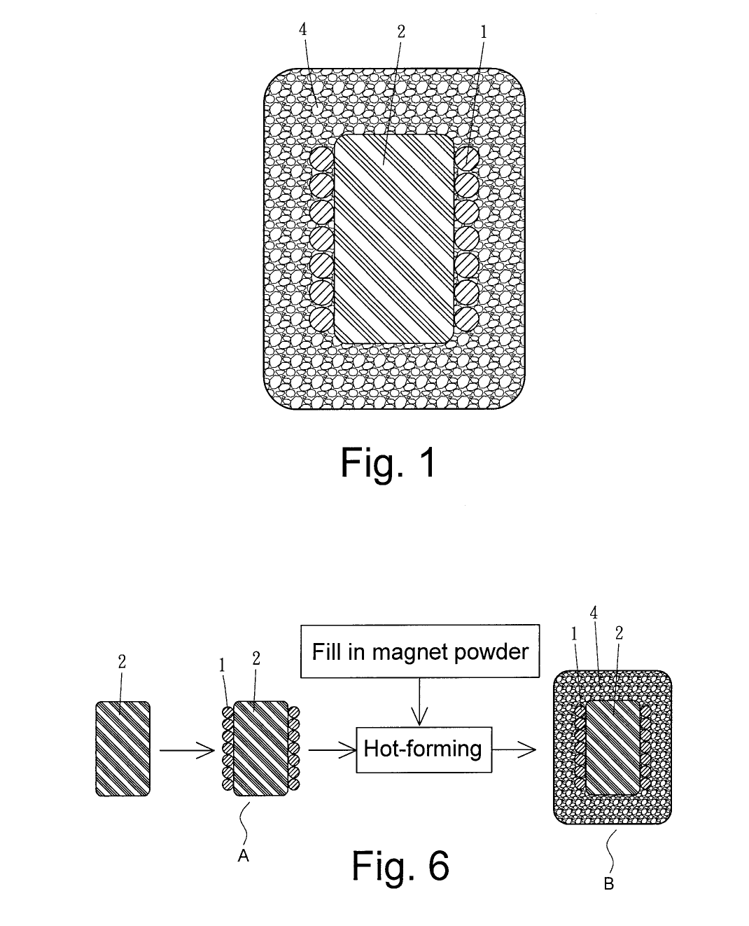

Referring to FIG. 1 for a sectional view of a hot-formed magnetic component according to the present invention, the hot-formed magnetic component includes a core 2, a current-carrying coil 1 wound around the core 2, and a magnetic shielding material 4 enclosing the core 2 and the current-carrying coil 1 by a hot-forming process.

The core 2 is made of a single magnetic material having low core loss and high permeability. Alternatively, the core 2 is made of a low core loss and high permeability composite magnetic material whose constituent materials possess different magnetic properties. On the other hand, the magnetic shielding material 4 includes a single magnetic material with high EMI shielding efficiency. Alternatively, the magnetic shielding material 4 includes a composite magnetic material which has high EMI shielding efficiency and whose constituent materials have different magnetic properties.

An applied magnetic field is generated when a current passes through the current-carrying coil 1. As a result, electromagnetic induction takes place in the magnetic materials of the core 2 and of the magnetic shielding material 4, thereby enhancing the overall output of magnetic field.

It is well known that the central region of the current-carrying coil 1 has the highest density of field lines. Therefore, the core 2 of the present invention, which has low core loss and is made of a single magnetic material or a composite magnetic material whose constituent materials have different magnetic properties, is located in the central region of the current-carrying coil 1 to enhance the induction of field lines.

When the core field line density increases, the low core loss property of the core 2 effectively prevents higher energy loss. In addition, since the magnetic shielding material 4 enclosing the core 2 and having high EMI shielding efficiency is capable of guiding field lines, the field lines are effectively contained in the component, thereby suppressing electromagnetic interference.

It can be known from the above description that the hot-formed magnetic component of the present invention has three main features:
a. The material properties of the low loss core 2 and of the magnetic shielding material 4 with high EMI shielding efficiency effectively maximize the field lines of the component while keeping electromagnetic wave interference and core loss at the minimum.
b. The volume proportion of the low loss core 2 and the magnetic shielding material 4 with high EMI shielding efficiency is well controlled so as to obtain the desired inductance and reduce core loss. Since high permeability and low loss materials are generally more expensive than common magnetic materials, the well-controlled volume proportion also contributes to proper cost control of the finished product.
c. With the low loss core 2 being tightly enclosed by the magnetic shielding material 4 with high EMI shielding efficiency, gaps which may otherwise be formed between elements in the component are eliminated, thereby preventing the generation of a turbulent magnetic field and increase in core loss.

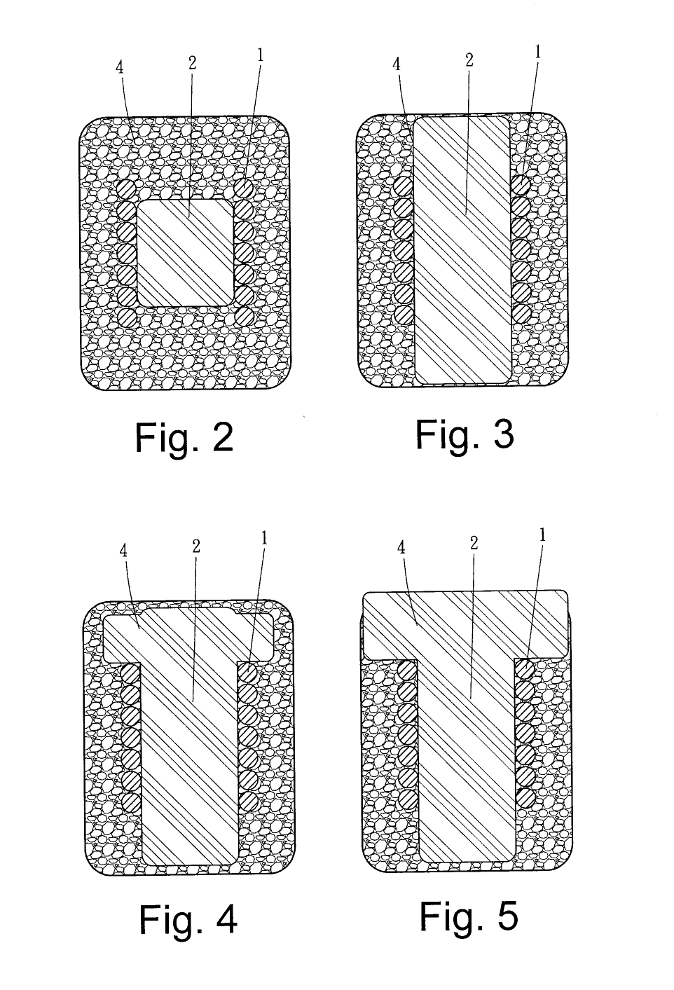

The hot-formed magnetic component of the present invention has the following variations. The proportion between the core 2 and the magnetic shielding material 4 may vary according to design and the required specifications, as explained hereunder with reference to FIG. 2 through FIG. 5. An increase in the volume of the core 2 effectively enhances inductance of the component and lowers core loss.

Please refer to FIG. 2 for a sectional view of a variation of the combination of the core 2 and the current-carrying coil 1. The relatively small core 2 and the relatively large magnetic shielding material 4 are suitable for a low-inductance component and achieve high EMI shielding efficiency.

In FIG. 3, the core 2 protrudes from both ends of the current-carrying coil 1. According to research findings, by extending the core 2 out of the current-carrying coil 1, congestion of field lines is effectively prevented, and inductance is increased by 20% to 50%.

In FIG. 4, the core 2 has a T-shaped cross section. This design is advantageous in that the area of contact between the core 2 and the magnetic shielding material 4 is increased, as well as the volume ratio of the core 2 to the magnetic shielding material 4. In consequence, loss of field lines at the contact surface between the core 2 and the magnetic shielding material 4 is effectively prevented while inductance is enhanced.

In FIG. 5, the volume proportion of the core 2 is further increased, thereby significantly raising inductance and lowering core loss.

Hence, the core 2 can be I-shaped, T-shaped, columnar, and so on. Meanwhile, the core 2 can be completely or only partially enclosed by the magnetic shielding material 4, depending on dimensions of the component.

The hot-forming fabrication method of a magnetic component according to the present invention includes the following processes:

### 1. Preparation of Hot-Forming Powder:

To prepare the hot-forming powder for use with the present invention, the following ingredients are provided:
a. Magnetic powder: The magnetic powder includes an iron powder such as Höganäs SC200, SC100.26 and Beipiao Shenglong BF200.27, BF100.27 or an iron alloy powder (Fe, Al, Si, Cr, Ni, Co). Alternatively, the magnetic powder includes other mixed powder having similar magnetic permeability, such as Sendust, Amorphous, MPP, and Hi-Flux.
b. Binder: A single specific resin or multiple specific resins, 4% to 20% by weight of the magnetic powder, are used for binding the magnetic particles during the hot-forming process. The specific resins include commonly used hot-forming materials such as polycarbonate (PC), polystyrene resin (PS), polyethylene (PE), nylon, and polypropylene (PP).
c. Lubricant: The lubricant, such as white wax, molybdenum disulfide, and polytetrafluornethylene (PTFE), weighing 0.05% to 3% of the magnetic powder, provides a lubricating effect during the hot-forming process and facilitates product release.

### 2. Powder Mixing:

In the present invention, powder mixing is carried out by a single-shaft or multi-shaft mixer commonly used in the industry. The steps of powder mixing include:
a. Pour in the magnetic powder (of a single kind or multiple kinds). Mix until uniform.
b. Repeat Step a. until all the magnetic powder is poured in and well mixed.
c. Add the single or multiple binder. Mix until uniform. If a wet type binder (containing a solvent such as ethanol or acetone) is used, mix until it is dry and no lumps can be found.
d. Repeat Step c. until all the binders are added and well mixed.
e. Add the lubricant. Mix until uniform.
f. Repeat Step e. until all the lubricant is added and well mixed.

### 3. Production of Finished Powder:

a. Confirm powder properties: After the powder is thoroughly mixed, measure the permeability, resistance, magnetic hysteresis curve, and bulk density of the powder. Its bulk density ranges from 2 to 4 g/cm³.
b. Sieve the powder: Pass the powder through a sieving machine. According to the magnetism required, sieves of different mesh sizes are used to sieve out powder of different particle sizes. Powder passing through 80 meshes is needed.
c. Heat treatment: Depending on the required magnetism, packaging density, fluidity, and green strength of the powder, an optional heat treatment is applied to the powder to improve its magnetism and compactability properties. The heat treatment is needed if the powder provides poor enclosure during the hot-forming process (e.g., there are apparent cracks on the outside, or the enclosure is incomplete). The heat treatment is performed prior to the hot-forming process and involves pre-heating the powder at 180 to 230° C., so as to allow the binder to cover the particles of the magnetic material in advance.

### 4. Hot-Forming of Magnetic Powder:

Referring to FIG. 6, the hot-formed magnetic component of the present invention is fabricated by the steps of:
a. winding the current-carrying coil 1 around the core 2, such that the current-carrying coil 1 and the core 2 form a magnetic energy storage component A; and
b. Putting component A in the mold. Then Filling in the magnetic powder of the magnetic shielding material 4 and performing a hot-forming process so as to obtain an enhanced hot-formed magnetic component B enclosed by the magnetic shielding material 4.

Therefore, the volume proportion of the current-carrying coil 1 and of the material surrounding the core 2 can be changed or adjusted with reference to the aforesaid component designs so as to achieve the desired product specifications. According to basic electromagnetics, inductance is in proportion to the square of the number of turns of the current-carrying coil 1. Hence, the inductance of the product can be adjusted by increasing or decreasing the number of turns. As the number of turns varies, the volume proportion of the current-carrying coil 1 winding around the core 2 is changed.

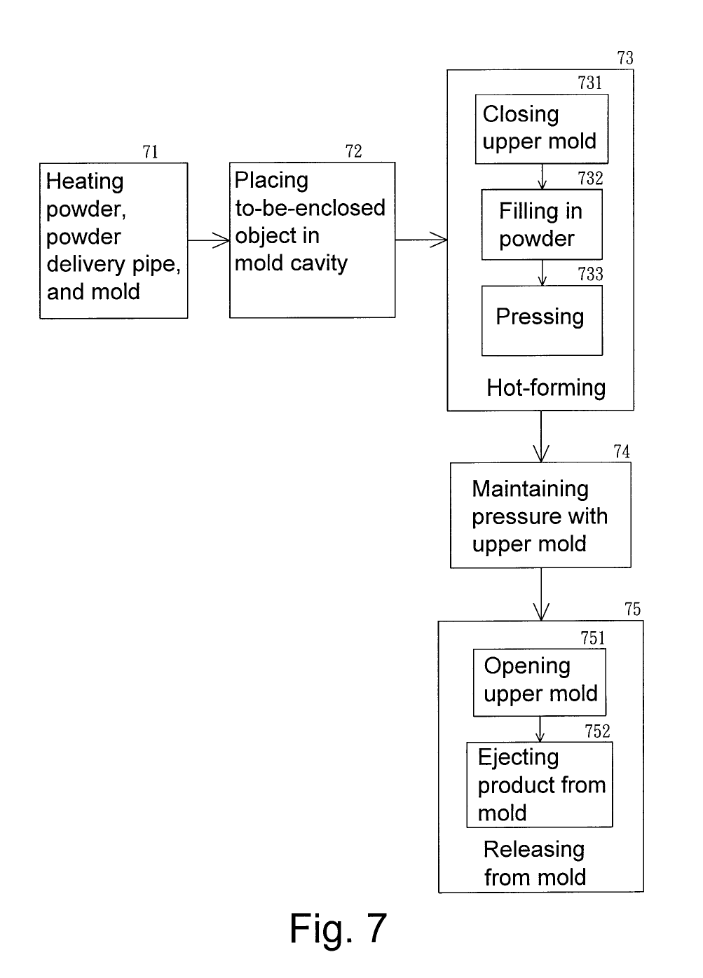

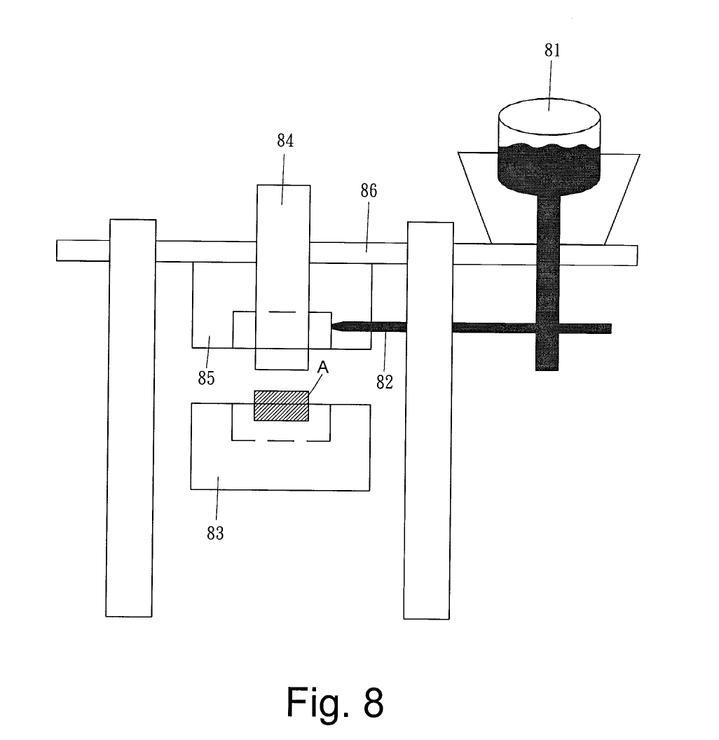

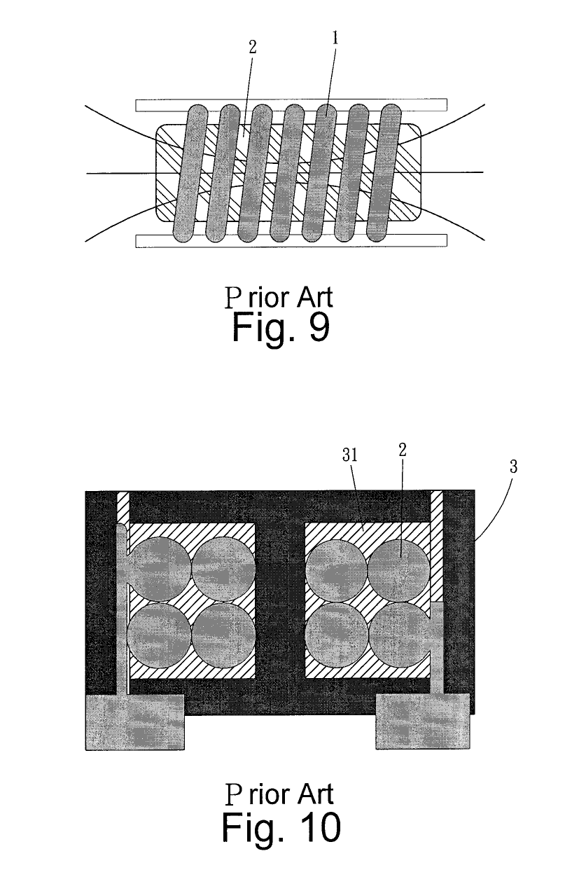

The actions involved in the magnetic powder hot-forming process of the present invention, as well as related notices and parameters, are described in detail with reference to FIG. 7 and FIG. 8, which are a flowchart of the magnetic powder hot-forming process and a schematic drawing of a hot-forming apparatus according to the present invention, respectively.

The hot-forming process of the present invention includes the following actions:

1. Heating a powder feedstock 81, a powder delivery pipe 82, and a mold 83 (Action 71): To ensure stability of the hot-forming properties of the powder, each of the powder feedstock 81, the powder delivery pipe 82, and the mold 83 is installed with a heater. The heating temperatures range from 140 to 350° C., depending on locations of the heaters.

2. Placing the object to be enclosed, i.e., the magnetic energy storage component A formed by the low loss core 2 and the current-carrying coil 1 wound therearound, into a mold cavity (Action 72). The following points should be taken into account when designing the to-be-enclosed object (i.e., the magnetic energy storage component A):
a. How the object is placed in position or gripped;
b. Where the object is to be positioned, and in what direction the hot-forming powder is to be filled;
c. The mechanical strength of the object; and
d. How the object is to be released from the mold.

3. Hot-forming with a pressing device 84 (Action 73): The hot-forming action is further divided into the following sub-actions:
a. Closing an upper mold 85 (Sub-action 731): The upper mold 85 is closed by means of the bilaterally provided guide rods 86.
b. Filling in the powder (Sub-action 732): The powder is filled into a powder filling area.
c. Pressing with an upper-mold pressing device 84 (Sub-action 733): The pressing device 84 is activated to press. As a result, the powder in the powder filling area enters the mold cavity and encloses the magnetic energy storage component A. By heating and pressing, the magnetic powder is softened/liquefied so as to cover the surface of the magnetic energy storage component A closely.

4. Maintaining the pressure with the upper mold 85 (Action 74): The upper-mold pressing device 84 remains still, thereby keeping the pressure on the pressed area. Otherwise, the hot-formed product may delaminate due to an insufficient forming time.

5. Releasing from the mold 83 (Action 75): The product-releasing action is further divided into:
a. Opening the upper mold 85 (Sub-action 751): The upper mold 85 is opened by means of the bilaterally provided guide rods 86.
b. Ejecting the product from the mold 83 (Sub-action 752): A product-releasing device is activated to eject the product upward. Thus, the product is released from the mold cavity along with the product releasing device and ready to be picked up manually or automatically.

While using the magnetic powder hot-forming technique of the present invention, please note the following:

1. Temperature tolerance of the magnetic powder: Since all the powder delivery pipes in the present invention need to be heated and kept warm, it is important to know if the magnetic properties of the magnetic material will deteriorate because of the heating temperatures.

2. Temperature tolerance of all additives (binder, lubricant): Since all the powder in the delivery pipes and feedstock in the present invention need to be heated and kept warm, it is important to know if the additives will be oxidized and decompose due to the heating temperatures. The heating temperatures should not exceed the thermal decomposition temperature of the binder. For example, the thermal decomposition temperature of polycarbonate (PC) is over 310° C.

3. Design of the filling gate of the mold cavity: The key factors influencing the filling gate design of the mold cavity are:
a. Density of the formed product: A well-dimensioned filling gate produces a high density of the formed product.
b. Resistance of the to-be-enclosed object (i.e., the magnetic energy storage component A) against friction: When pressed, the hot-forming powder rubs against the to-be-enclosed object (i.e., the magnetic energy storage component A) at high speed and may therefore damage the internal parts of the unit or the component. Hence, attention should be paid to the angle, position, and dimensions of the filling gate as well as pre-treatment of the to-be-enclosed object (i.e., the magnetic energy storage component A).
c. Burrs: A well-designed filling gate helps reduce burrs.

The present invention is further demonstrated by an embodiment thereof. It should be understood that the embodiment is provided for illustrative purposes only and in no way limits the scope of the present invention.

### Embodiment

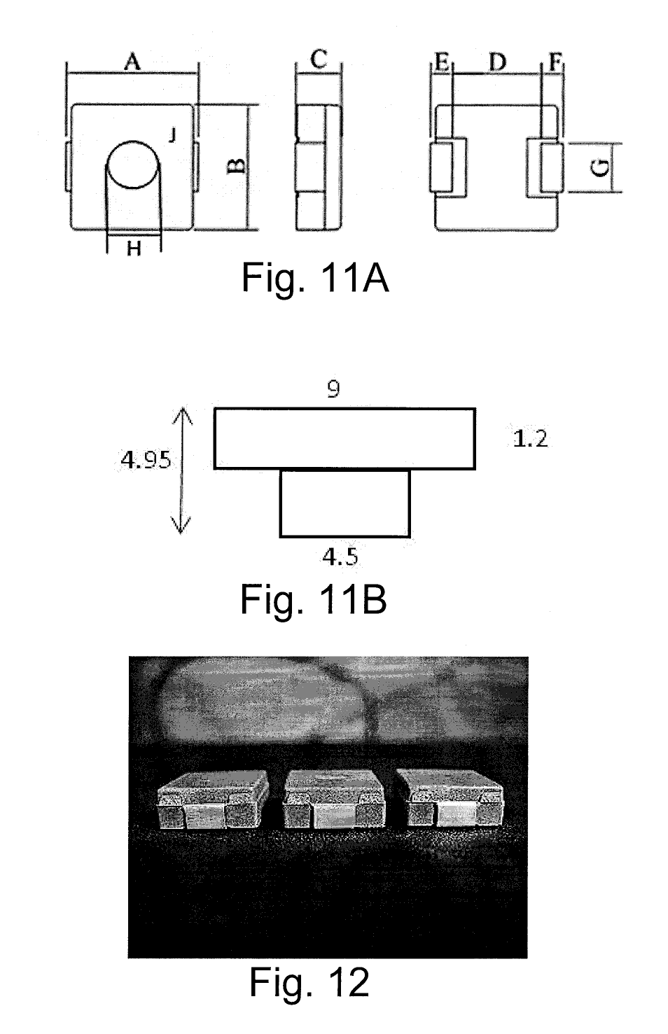

A surface-mounted device, more particularly a surface-mounted inductor, is exemplified herein as an embodiment of the present invention. The dimensions of the device are shown in FIG. 11A and Table 1.

TABLE 1

| | Dimension (mm) | Description |
|---|---|---|
| A | 12.8 | Length of device |
| B | 12.8 | Width of device |
| C | 5.20 | Height of device |
| D | 9.0 | Distance between pads |
| E | 2.3 | Length of the left pads |
| F | 2.3 | Length of the right pads |
| G | 5 | Width of the pads |
| H | See note* below. | Exposed diameter of iron core 2 |
| J | | Magnetic shielding material 4 |

*The dimension H includes the following three dimensions for use in different experiment conditions, with a view to examining how volume variation of the iron core affects power consumption: X: The diameter is 0 mm, meaning absence of iron core. Y: A columnar iron core, made of a Fe—Al—Si alloy, has a diameter of 4.5 mm and a height of 4.95 mm. Z: A T-shaped iron core has the dimensions indicated in FIG. 11B and is made of a Fe—Al—Si alloy.

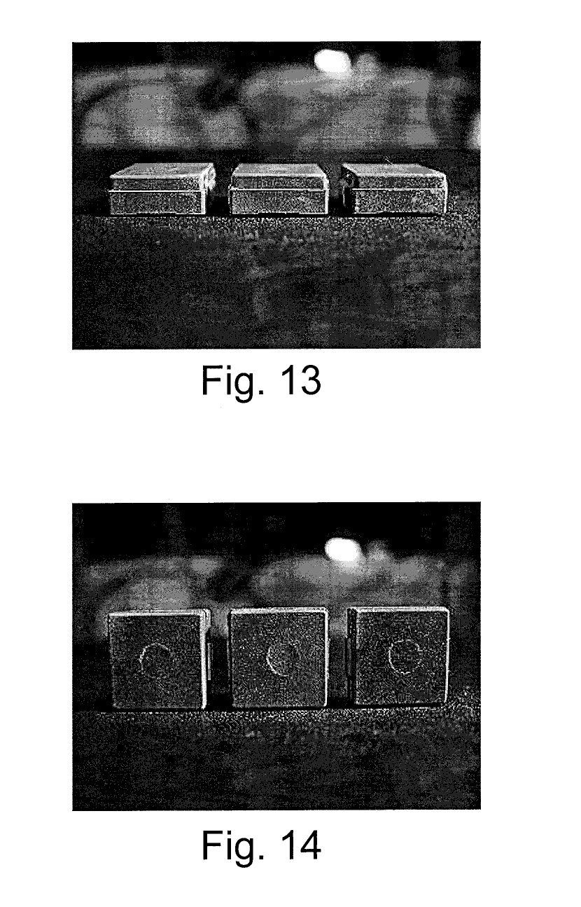

Pictures taken of the finished devices are shown in FIG. 12 in a side perspective view, FIG. 13 in a front perspective view, and FIG. 14 in a top view (wherein the iron core 2 has a diameter of 4.5 mm).

### Experiment Conditions:

Iron cores 2 of different dimensions were fabricated and placed in corresponding coils (each having a wire diameter of 1.2 mm, a coil inner diameter of 4.6 mm, and 2.5 turns). Then, the resultant assemblies were respectively enclosed by the magnetic shielding material 4. The finished devices were measured to get their inductance and power consumption.

### Test Conditions:

For inductance measurement: frequency: 500 KHz, AC voltage: 1 V.

For power consumption measurement: frequency: 300 KHz, AC voltage: 1 V, DC current: 30 A.

### Experiment Results and Discussion:

TABLE 2

| | X | Y | Z |
|---|---|---|---|
| Volume of iron core (mm³) | 0 | 25.1 | 43.3 |
| Volume percentage (%) | 0 | 3 | 5.20 |
| Inductance (μH) | 0.414 | 0.511 | 0.71 |
| Inductance increase rate (%) | | 23.43 | 71.50 |
| Power consumption (Watt) | 8.15 | 6.98 | 6.31 |
| Power consumption decrease rate (%) | | 14.36 | 22.58 |

As shown in Table 2, inductance was raised, and power consumption reduced, by increasing the volume percentage of the high permeability and low loss iron core.

The above said is only a preferred embodiment of the present invention. The embodiment is provided for illustrative purposes only but not intended to limit the scope of the present invention. As would be understood by a person of skill in the art, various equivalent changes or modifications can be made to the disclosed embodiment without departing from the spirit and principle of the present invention. Therefore, all such equivalent changes or modifications should be encompassed by the appended claims.

What is claimed is:

1. A hot-forming fabrication method of a magnetic component, comprising steps of:
winding a current-carrying coil around a core so as to form a magnetic energy storage component;
placing the magnetic energy storage component in a mold, and disposing a magnetic shielding material around the magnetic energy storage component; and
performing a hot-forming process so as to obtain a hot-formed magnetic component enclosed by the magnetic shielding material.

2. The hot-forming fabrication method of claim 1, wherein the core comprises a magnetic induction core bar, as one enclosed in a common magnetic component, or is made of a single low loss and high permeability magnetic material or a low loss and high permeability composite magnetic material whose constituent materials possess different magnetic properties.

3. The hot-forming fabrication method of claim 1, wherein the magnetic shielding material comprises a common magnetic shielding material made of a magnetic powder, a binder, and a lubricant uniformly mixed together or comprises a single magnetic material with high EMI shielding efficiency or a composite magnetic material which has good EMI shielding efficiency and whose constituent materials have different magnetic properties.

4. The hot-forming fabrication method of claim 3, wherein the magnetic powder comprises an iron powder selected from the group consisting of SC200, SC100.26 and Beipiao Shenglong BF200.27, BF100.27 or an iron alloy powder (Fe, Al, Si, Cr, Ni, Co), or comprises a mixed powder with similar magnetic permeability selected from the group consisting of Sendust, Amorphous, MPP, and Hi-Flux; wherein the binder comprises a single specific resin or multiple specific resins, 4% to 20% by weight of the magnetic powder, for binding magnetic particles during the hot-forming process, the single or multiple specific resins comprising a common hot-forming material selected from the group consisting of polycarbonate (PC), polystyrene resin (PS), polyethylene (PE), nylon, and polypropylene (PP) etc.; and wherein the lubricant, 0.05% to 3% by weight of the magnetic powder, comprises one selected from the group consisting of white wax, molybdenum disulfide, and polytetrafluornethylene (PTFE) etc., for providing lubrication during the hot-forming process and thereby facilitating product release.

5. The hot-forming fabrication method of claim 1, wherein the hot-forming process comprises steps of:
heating the magnetic shielding material to 140 to 350° C. so as to soften and liquefy the magnetic shielding material; and
pressing the magnetic shielding material with a pressing device, such that the current-carrying coil and the core are enclosed by the magnetic shielding material and thus provided with a complex form feature selected from the group consisting of a bent part, a hollow part, and a delicated-part.

6. A hot-formed magnetic component, comprising:
a core;
a current-carrying coil wound around the core; and
a magnetic shielding material enclosing the core and the current-carrying coil by a hot-forming process.

7. The hot-formed magnetic component of claim 6, wherein the core comprises a magnetic induction core bar, as one enclosed in a common magnetic component, or is made of a single low loss and high permeability magnetic material or a low loss and high permeability composite magnetic material whose constituent materials possess different magnetic properties.

8. The hot-formed magnetic component of claim 6, wherein the magnetic shielding material comprises a common magnetic shielding material made of a magnetic powder, a binder, and a lubricant uniformly mixed together or comprises a single magnetic material with high EMI shielding efficiency or a composite magnetic material which has good EMI shielding efficiency and whose constituent materials have different magnetic properties.

9. The hot-formed magnetic component of claim 6, wherein the magnetic shielding material encloses the current-carrying coil and the core completely or partially, depending on dimensions of the magnetic component.

10. The hot-formed magnetic component of claim 6, wherein a volume ratio between the core and the magnetic shielding material is adjustable so as to achieve desired inductance, core loss, and related electromagnetic properties.

11. The hot-formed magnetic component of claim 6, wherein the core protrudes from the current-carrying coil so as to effectively prevent congestion of magnetic field lines and increase inductance by 20% to 50%.

12. The hot-formed magnetic component of claim 6, wherein the core is T-shaped so as to increase an area of contact between the core and the magnetic shielding material and a volume ratio of the core to the magnetic shielding material, thereby effectively preventing loss of magnetic field lines at a contact surface between the core and the magnetic shielding material while increasing inductance.

13. The hot-formed magnetic component of claim 6, wherein the core has an increased volume proportion so as to significantly increase inductance and lower core loss.

14. The hot-formed magnetic component of claim 6, wherein the core is I-shaped, T-shaped, or columnar etc.
